(19) United States
(12) Patent Application Publication
(10) Pub. No.: US 2002/0130748 A1
(43) Pub. Date: Sep. 19, 2002

(54) Transformer winding

(76) Inventors: Jakob Rhyner, Zurich (CH); Rolf Luchsinger, Kirchdorf (CH); Martin Lakner, Birmenstorf (CH)

Correspondence Address: Robert S. Swecker, BURNS, DOANE, SWECKER & MATHIS, L.L.P., P.O. Box 1404, Alexandria, VA, 22313-1404, US

(21) Appl. No.: 10/043,136

(22) Filed: Jan. 14, 2002

(30) Foreign Application Priority Data
Jan. 23, 2001 (EP) 01810067.7

(51) Int. Cl. H01F 27/28

(52) U.S. Cl. 336/182

(57) ABSTRACT

The proposed modular transformer concept is based on a production process in two steps, which separates the fabrication of the turns from the assembly of the transformer, and thus combines automation potential and flexibility. Both the high-voltage winding and the low-voltage winding are composed of effectively two-dimensional spiral conductor tracks (21,22). These conductor tracks can be produced in a computer-aided manner, and then just need to be stacked and electrically connected. Special insulator layers (11,12) are inserted between the conductor tracks and on the one hand bear the weight while on the other hand providing optimum electrical insulation, so that the distances between the high-voltage and low-voltage conductor tracks can be reduced, and the losses in the conductors as well as the short-circuit impedance of the winding can be decreased.

### TECHNICAL FIELD

The present invention relates to the field of transformer construction, and relates in particular to a transformer winding having a high-voltage and a low-voltage winding.

### PRIOR ART

The production of conventional, wound power transformers involves a high proportion of costly manual work due to the interaction between the complicated winding technology and the electrical insulation that is required. Furthermore, transformers for the field of power transmission with ratings of 10-500 MVA are not large-scale produced products, and are manufactured to customer requirements, so that, in practice, this invariably results in unavoidable development or adaptation costs. Conventional production of power transformers does not have any significant automation potential. However, alternative production concepts in which, for example, use is made of a limited number of standardized, prefabricated semi-finished products, often result in reductions in flexibility.

Conventional power transformers also have a current-limiting function owing to the impedance which is produced by the magnetic stray fields between the high-voltage and the low-voltage winding. What is referred to as the short-circuit impedance X_{cc} is characterized by the ratio of the operating current to the short-circuit current, that is to say a transformer with a short-circuit impedance X_{cc} of N% limits the short-circuit current to 100/N times the operating or rated current. Power transformers normally have short-circuit impedances of 10-15%. Conventional, wound transformers with a low short-circuit impedance of a few percent are very expensive to manufacture, since the turns must be interleaved in a complex manner in order to reduce the stray fields.

European Patent Application EP-A 0 354 121 discloses a transformer for supplying power to electrical circuits. This has a high-voltage and a low-voltage winding, both of which are formed from flat, identical conductor tracks in the form of a single turn. The conductor tracks of the high-voltage winding and those of the low-voltage winding are arranged differently, and alternate. The former are connected electrically in series and the latter electrically in parallel via connection elements, so that the ratio between the high voltage and the low voltage is equal to the number of high-voltage conductor tracks, and a current of the same intensity flows in all the conductor tracks. Non-integer transformation ratios are therefore impossible. Said connection elements at the same time act as heat dissipators and supports for the conductor tracks, and the axis of the transformer is accordingly provided horizontally, that is parallel to the earth's surface.

### DESCRIPTION OF THE INVENTION

The object of the present invention is to specify a transformer winding which can be produced easily. This object is achieved by a transformer winding having the features of patent claim 1, and by a method for producing such a transformer winding having the features of patent claim 10.

The essence of the invention is to construct a transformer winding composed of planar conductor tracks, which are arranged following one another and are separated from one another by suitable spacing and insulation elements. This modular transformer construction avoids the need for the labor-intensive winding process with the conventional conductor wire.

The proposed transformer concept is based on a production process which, in two steps, first of all comprises the fabrication of the turns and then their assembly to form the transformer, hence combining automation potential and flexibility. Both the high-voltage winding and the low-voltage winding are formed from effectively two-dimensional, preferably spiral conductor tracks. These conductor tracks each have at least one turn, and the corresponding structure can be produced by machine. The conductor tracks are then arranged in the desired sequence, and are electrically connected to form a winding. Insulation and spacing elements are inserted between the conductor tracks and, firstly, provide optimum electrical insulation while, secondly, ensuring mechanical robustness despite the unavoidable electromagnetic forces and vibration.

In a first embodiment of the transformer winding according to the invention, the spacing elements are subdivided into a number of partial elements or have cutouts or channels, through which a cooling liquid can circulate in order to cool the conductor tracks during operation of the transformer.

According to a second embodiment, the transformer axis is provided vertically, that is to say at right angles to the earth's surface. This arrangement is self-supporting, and only the lowermost conductor track need be supported and, possibly, electrically insulated from the core or housing of the transformer.

According to a further embodiment, the conductor tracks of the high-voltage winding and those of the low-voltage winding are each identical to one another, so that only two different conductor track types need be manufactured and stocked.

According to a further embodiment, the high-voltage and low-voltage conductor tracks are combined in pairs to form modules. The current density integral over a module cross section which lies in a plane including the transformer axis is in this case approximately equal to zero, that is to say the total current intensity integrated over all the turns in the low-voltage conductor track is equal and opposite to that in the high-voltage conductor track. In consequence, significant magnetic stray fields can be found only in the region of the insulation element, which means that the winding has a low impedance.

According to a further embodiment, the overall conductor track widths are of equal magnitude, thus also minimizing the magnetic field components in those conductors which are at right angles to the plane of the conductor tracks and which are responsible for a large proportion of the alternating current losses.

According to a further embodiment, the low-voltage conductor tracks and the high-voltage conductor tracks are each electrically connected in series. The transformation ratio which is defined by the total number of turns is governed by the ratio of the number of turns in each module. Any desired non-integer rational transformation ratios are feasible.

According to a further embodiment, only one type of module is used and, for this purpose, every alternate module is inverted, so that each low-voltage conductor track in a first module is adjacent to the low-voltage conductor track of the next module, and only spacing elements are required between these two modules.

Further advantageous embodiments are described in the further dependent patent claims.

### BRIEF DESCRIPTION OF THE FIGURES

The invention will be explained in more detail in the following text with reference to exemplary embodiments and in conjunction with the drawings, in which:

FIG. 1 shows an oblique view of a fundamental design for a three-phase transformer,

FIG. 2 shows a module comprising an insulation element, a high-voltage conductor track and a low-voltage conductor track, in the form of a planned view and a section,

FIG. 3 shows a detail from a section through an arrangement having six modules.

The reference symbols used in the drawings are summarized in the list of reference designations. In principle, identical parts have the same reference symbols.

### APPROACHES TO IMPLEMENTATION OF THE INVENTION

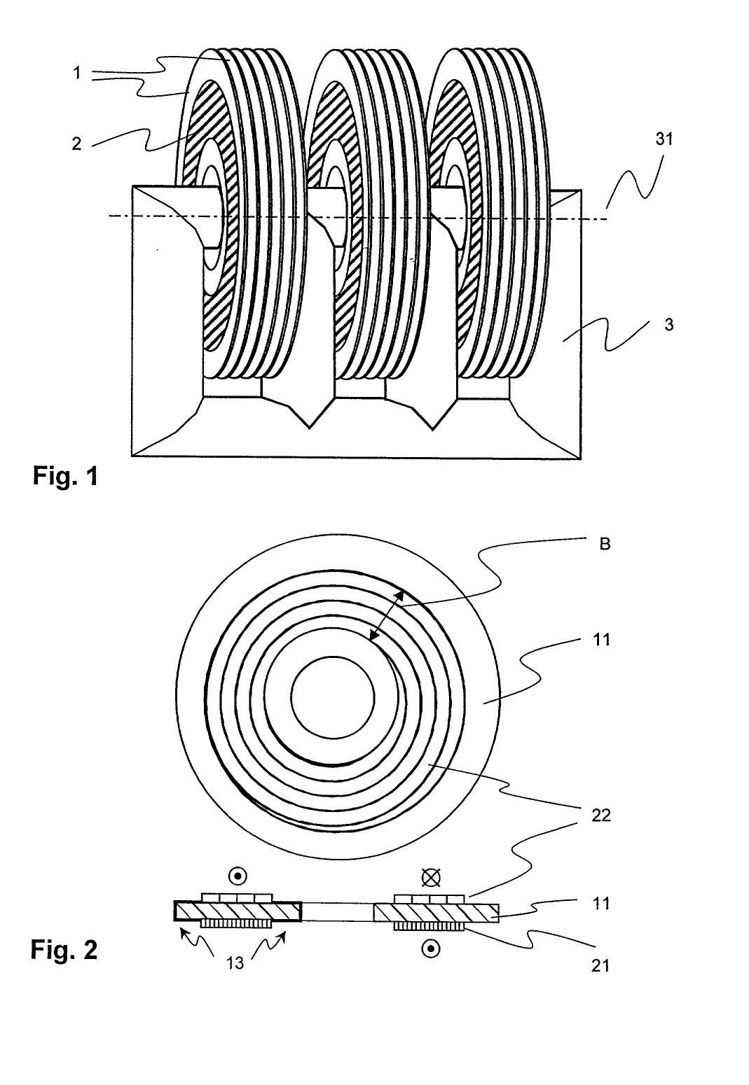

FIG. 1 shows a fundamental design of a three-phase transformer with windings according to the invention. Conductor tracks 2 are arranged on or between insulation or spacing elements 1, only one of which is in each case visible, per phase, in FIG. 1. Instead of having a round, annular geometry, the elements 1 and/or the conductor tracks 2 may also have a rectangular shape. The transformer core 3 passes through a central opening in the elements 1, in the direction of the transformer axis 31. The three-phase transformer core in FIG. 1 has what is referred to as a shell-type topology although, for example, a core-type topology is also possible, or the transformer axis 31 may be aligned vertically. Analogously to the configuration of the core in classic wound transformers, criteria such as iron losses and volume must also be taken into account here. At least in the case of power transformers, a thermally conductive cooling and/or electrical insulation liquid, for example oil or liquid nitrogen in the case of high-temperature superconducting conductors, surrounds the windings. The tank or cryostat for holding this liquid as well as the electrical connecting conductors on the high-voltage and low-voltage windings are not shown in FIG. 1. The transformer core and cooling liquid will not be considered any further in the following text.

FIG. 2 shows a module comprising an insulation element 11 in the form of a disk or plate, a high-voltage conductor track 21 and a low-voltage conductor track 22. The low-voltage conductor track 22 has four spiral turns while, in contrast, the high-voltage conductor track 21 comprises a total of twelve turns, and can be seen in the form of a section under the insulation element 11 in FIG. 2. In the present case, the two conductor tracks have been structured from an annular conductive region of overall conductor width B. In a module such as this, the dielectric characteristics of the insulation element 11 are of critical importance, with not only the breakdown field strength of the material of the insulation element 11 but also its geometric configuration being important. What are referred to as leakage currents or creepage currents can flow between a high-voltage conductor track 21 and a low-voltage conductor track 22 on the surface of the insulation element 11 along leakage current paths 13, two examples of which are represented by bold lines in FIG. 2. As a precaution against the latter, all the leakage current paths 13 are set such that their length is a minimum. This is achieved by choosing the radial extent of the insulation element 11, that is to say its annular width, to be considerably greater than the overall conductor width B of the conductor tracks 21,22.

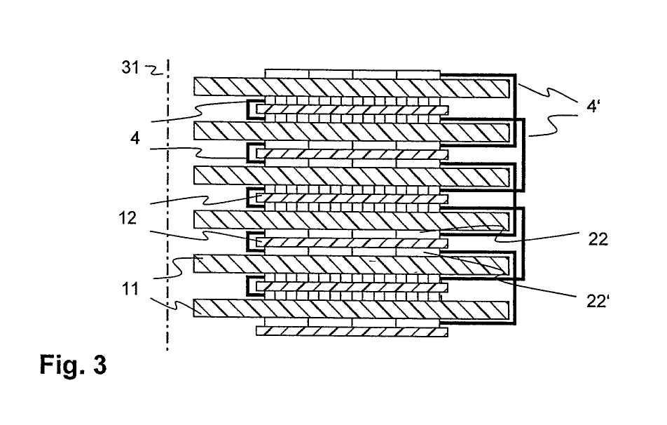

FIG. 3 shows a detail from a section along a transformer axis 31 of an arrangement having six modules as shown in FIG. 2. The individual high-voltage and low-voltage conductor tracks are electrically connected to one another via connection elements 4,4′ to form an unconventional high-voltage or low-voltage winding. These windings therefore do not have conventional coils in the form of a three-dimensional helix, but planar conductor tracks arranged at discrete distances from one another. Spacing elements 12 are provided between adjacent conductor tracks 22, 22′, and are associated with the same winding. Although the spacing elements 12 also need to have a certain dielectric strength, their main function is mechanical, as spacers and vibration dampers. In contrast to the insulation elements 11, the spacing elements 12 are subdivided into, for example, radially arranged partial elements in the form of spokes, or are at least provided with cutouts, channels or cavities, which are filled with said coolant during operation. In the arrangement shown in FIG. 3, insulation and spacing elements 12 alternate, so that each conductor track is cooled on at least one side. The low-voltage conductor track 22 of one module is thus followed by the low-voltage conductor track 22′ of the adjacent module, that is to say every alternate module is inverted. As an additional advantage of this arrangement, it is possible to use identical modules since this maintains the rotation sense of the currents at the transition from one module to the next. The arrangement shown in FIG. 3 thus requires only a limited number of just four basic units (high-voltage and low-voltage conductor tracks, insulation and spacing elements), as well as the connection elements.

It is, of course, also possible to assemble said basic units in a different way to form modules or very small transformer units. This is because the term module actually refers more to a logical unit than a physical unit. Different arrangements of the basic units than those shown in FIG. 3 are also feasible. It is also possible to use a number of module types, in particular, it is feasible to choose a different overall conductor track width, or different structuring, for example fewer, broader turns for this purpose, for the first and/or last conductor track of a winding.

The inductive impedance of a transformer is governed mainly by the volume of the areas where the magnetic fields are strong, and rises with the square of the field strength. In classic, wound transformers, the radial distance between the hollow-cylindrical low-voltage coil and the high-voltage coil, which is coaxial with it, is the governing factor. In a module as shown in FIG. 2, the opposite rotation sense of the currents in the high-voltage and low-voltage conductor tracks, as indicated in the section view, means that the magnetic fields are strong only between the conductor tracks, that is to say in the area of the insulation element 11, and in the area of the conductor tracks immediately adjacent to this. However, the desired effect is achieved only if, with the constant current density, the overall cross-sectional areas of the high-voltage and low-voltage conductor tracks are of equal magnitude, irrespective of the respective subdivision into turns. The interleaved arrangement of a number of modules as shown in FIG. 3 additionally reduces the residual stray fields outside the modules, that is to say in the area of the spacing elements 12. If the thickness of the insulation element 11 is set to the dielectrically minimum value, stray impedances of one percent or less can be achieved. However, in contrast to this, if the aim is to achieve an impedance of a conventional level the distance between the high-voltage and low-voltage conductor tracks may be chosen to be greater, or the field-compensating module formation as shown in FIG. 2 may be entirely dispensed with by the arrangement of the conductor tracks being less interleaved.

A further criterion is the I²R losses and the alternating current losses caused by the time-dependent magnetic fields in the conductor itself. The latter are at least linearly related to the magnetic field amplitude and are also referred to as eddy-current losses in metallic conductors and hysteresis losses in superconductors, and occur there even if the alternating current amplitude is below the critical direct current intensity. If the conductor tracks are flat, as in the present case, the magnetic field components at right angles to the plane of these conductor tracks are mainly those of importance. If the magnitude of the surface current density in the high-voltage and low-voltage conductor tracks is now the same locally in the module shown in FIG. 2, and the two conductor tracks thus have the same, overall conductor track or ring width B, said vertical magnetic field components in the conductors also provide the maximum compensation for themselves, further reducing the losses. A maximum reduction in the losses in the conductors as shown in FIG. 3 thus invariably also results in a reduction in the fields between the conductor tracks, and hence in the transformer winding having a low short-circuit impedance.

In order to reduce said alternating current losses further, at least the low-voltage conductors can be subdivided into a number of parallel partial conductors. As a precaution against asymmetry, which increases the losses in the magnetic fields and in the current distribution in the partial conductors, such parallel routing requires, however, transposition of the partial conductors, that is to say interchanging of an inner partial conductor with an outer partial conductor, or an upper partial conductor with a lower partial conductor. One suitable way to carry out this transposition is in the connection elements 4, that is to say at the junction from one module to the next.

Said conductor tracks may be composed not only of metallic conductors, for example of copper or aluminum, but may also be composed of high-temperature superconducting materials. High-temperature superconductors are ceramic materials which have a negligible electrical resistance for currents below a critical current I_{c} when the temperature is below a critical temperature T_{c}. Thin monocrystalline or highly textured superconducting layers are grown on a substrate by means of vacuum processes such as PVD (Physical Vapor Deposition), CVD (Chemical Vapor Deposition), IBAD (Ion Beam Assisted Deposition), ISD (Inclined Substrate Deposition), PLD (Pulsed Laser Deposition) or EBE (Electron Beam Evaporation) or, as an alternative to these, by using what are referred to as sol-gel processes such as LPE (Liquid Phase Epitaxy). For superconductors in the YBCO family, for example, the layer thicknesses on a sapphire substrate are less than 5 μm. These processes for applying a thin superconducting layer at the same time allow the formation of a two-dimensional structure by interaction with a suitable mask technique.

Polycrystalline melt-processed superconductors of the Bi₂Sr₂CaCu₂O₈ type have thicknesses of between 50 and 5000 μm, and are frequently mechanically supported and protected by a base in the form of a glass-fiber synthetic. The high-temperature superconductors are normally also stabalized electrically by means of a normally conductive bypass connected electrically in parallel.

Various processes can be used to produce structures such as a spiral from a continuous normally conductive or high-temperature superconducting layer. These include etching processes, in which the conductive layer underneath is at least partially removed through openings in a mask composed of a suitable photoresist. Other processes for selective material removal include water jet cutting, laser cutting, milling or stamping. The structure to be produced may be rectangular or round, has a central opening for the transformer core and is preferably defined by means of CAD or produced by means of CAM. The radially offset turns of a conductor track are then electrically insulated from one another by means of a varnish. The resultant conductor track is then pressed or bonded onto an insulation or spacing element. A superconducting layer can be structured directly on its substrate or base, with the latter carrying out the function of an insulation or spacing element.

There are a large number of conditions and parameters that need to be taken into account when designing a transformer. For example, it is necessary to reach a compromise between the losses in the conductor and those in the iron core, and between the conductor length and the conductor cross section. Suitable materials for the insulation element include, for example, pressboard or polymers such as polyethylene, polypropylene, polyprolene, polyvinylchloride or polyethyleneterephthalate with breakdown field strengths in the order of magnitude of 10 kV/mm and mean leakage current field strengths in the order of magnitude of 0.1 to 2 kV/mm. A numerical exemplary embodiment based on a mean leakage current field strength of 0.5 kV/mm allows a comparison between a conventional, wound transformer and two modular transformers according to the invention and with the same rating, with conductor tracks composed of copper or of a high-temperature superconductor:

| | | Modular | |
|---|---|---|---|
| | Modular | transformer | |
| | transformer with | with copper | |
| | superconducting | conductor | Conventional |
| | conductor tracks | tracks | transformer |
| Rating [MVA] | 50 | 50 | 50 |
| Voltage [kV] | 110/18 | 110/18 | 110/18 |
| Current [A] | 262/1604 | 262/1604 | 262/1604 |
| 489/80 | 489/80 | 642/105 | |
| No. of modules | 30 | 20 | — |
| Volume [m³] | 4 | 4 | 5.0 |
| Radius [m] | 0.9 | 0.8 | 0.5 |
| Height [m] | 0.5 | 0.7 | 1.8 |
| Current density | 30.0/30.0 | 2.0/2.0 | 2.26/2.45 |
| [A/mm²] | | | |
| Total losses [kW] | 138 | 164 | 166 |
| Inductance X_{cc} [%] | 0.1 | 0.3 | 9.8 |

In an ideal situation, only the unstructured conductive layers need be stocked. Depending on the application and specification of the transformer, the desired structures, that is to say the number of turns of the spiral conductor track, can be worked out from this.

The conductor tracks are then stacked on top of one another in the desired sequence, together with the spacing and insulation elements, a task which is suitable for being transferred to a robot, and are electrically connected. The proportion of manual work and hence the production costs can be reduced significantly by the method according to the invention.

List of Reference Symbols

1 Conductor tracks

11 Insulation element

12 Spacing element

13 Leakage current path

2 Conductor tracks

21 High-voltage conductor track

22 Low-voltage conductor track

3 Transformer core

31 Transformer axis

4 Connection element

1. A transformer winding, which is centered around a transformer axis (31) and is designed for a transformation ratio N from high voltage to low voltage, having
a) a high-voltage winding comprising a number of high-voltage conductor tracks (21) which are electrically connected to one another via connection elements (4) and are aligned at right angles to the axis (31),
b) a low-voltage winding comprising a number of low-voltage conductor tracks (22) which are electrically connected to one another via connection elements (4) and are aligned at right angles to the axis (31),
c) electrical insulation elements (11) in the form of plates between each low-voltage conductor track (22) and an adjacent high-voltage conductor track (21),
d) spacing elements (12) between each two adjacent low-voltage conductor tracks (22, 22′) and between each two adjacent high-voltage conductor tracks.

2. The transformer winding as claimed in claim 1, characterized in that the spacing elements (12) comprise a number of partial elements or have cutouts, in which a cooling liquid can circulate.

3. The transformer winding as claimed in claim 1, characterized in that the transformer axis (31) is aligned vertically, and the conductor tracks (21,22) are arranged one on top of the other.

4. The transformer winding as claimed in claim 1, characterized in that all the low-voltage conductor tracks (22) and all the high-voltage conductor tracks (21) are each in the same form and have the same structuring.

5. The transformer winding as claimed in claim 1, in which the same numbers of low-voltage conductor tracks and high-voltage conductor tracks are provided, characterized in that each low-voltage conductor track (22) has an adjacent high-voltage conductor track (21) and forms a module with the former, including the insulation element (11), in that total current intensities which are at least of approximately the same magnitude flow in the high-voltage conductor track (21) and in the low-voltage conductor track (22) in each such module, and in that the magnetic fields outside the modules are compensated for by means of the currents in the conductor tracks in the modules.

6. The transformer winding as claimed in claim 5, characterized in that the overall width of the low-voltage conductor track (22) for each module is at least approximately equal to the overall width of the high-voltage conductor track (21).

7. The transformer winding as claimed in claim 5, characterized in that all the high-voltage conductor tracks and all the low-voltage conductor tracks are connected in series, and in that, for each module, the ratio of the number of turns of the high-voltage conductor track (21) to the number of turns of the low-voltage conductor track (22) is at least approximately equal to the transformation ratio N.

8. The transformer winding as claimed in claim 7, characterized in that all the low-voltage conductor tracks and all the high-voltage conductor tracks are each in the same form and have the same structuring, and in that each low-voltage conductor track has a further adjacent low-voltage conductor track.

9. The transformer winding as claimed in claim 1, characterized in that the low-voltage conductor tracks, in particular, are subdivided into at least two partial conductor tracks which are connected electrically in parallel and are routed geometrically parallel, and in that the partial conductor tracks are transposed in the connection elements (4).

10. A method for producing a transformer winding as claimed in claim 1, characterized in that the spiral low-voltage and high-voltage conductor tracks are structured from one continuous electrically conductive layer, and are then arranged at right angles to the transformer axis (31) and are electrically connected to one another.
